(19) United States
(12) Patent Application Publication
(10) Pub. No.: US 2007/0096434 A1
(43) Pub. Date: May 3, 2007

(54) Collapsible stroller

(76) Inventor: Christian Haeggberg, BAZENHEID (CH)

Correspondence Address: SHOEMAKER AND MATTARE, LTD, 10 POST OFFICE ROAD - SUITE 110, SILVER SPRING, MD, 20910, US

(21) Appl. No.: 10/580,431

(22) PCT Filed: Nov. 20, 2004
(86) PCT No.: PCT/EP04/13201

§ 371 Date: Jul. 10, 2006

(30) Foreign Application Priority Data
Dec. 2, 2003 (EP) 03027640.6
Sep. 3, 2004 (EP) 04020939.7

(51) Int. Cl. B62B 7/00

(52) U.S. Cl. 280/642

(57) ABSTRACT

Abstract: Collapsible stroller with a seat element (1), a seat back (2), a first mounting (3) for at least one front wheel (5), a second mounting (4) for at least two rear wheels (6) and a pushing-device (8) and a folding device (7). The seat element (1), the seat back (2) and the first and the second mounting (4) are each attached on one side to the folding device (7) to be able to pivot. The folding device (7) has pivot joints for pivoting the seat element (1), the seat back (2) and the first and the second mounting (4).

The device relates to a collapsible stroller with a folding device consisting of pivot joints according to the independent claim.

Collapsible strollers can be stored in a space-saving manner and are portable and therefore offer an effective alternative to rigid strollers. A plurality of collapsible strollers is already known. The folding mechanism in made as a scissors mechanism in most. One example of such a stroller is disclosed in EP 0 908 730. Scissors mechanisms however have the disadvantage that the length of the stroller when collapsed is not reduced. Especially when the stroller is to be carried as flight baggage is this a problem. Moreover the angles between the scissors joints are coupled to one another so that not just any settings between the seat surface, the seat back and the mountings for the front and rear wheels are possible.

DE 196 54 569 discloses a collapsible stroller in which the tilt of the seat back can be adjusted without changing the tilt of the seat surface. The folding mechanism of this stroller is however complex and has the same disadvantage as conventional scissors mechanisms: The length of the stroller in the collapsed state is no less than in the operating state.

The object of the invention is to devise a collapsible stroller which avoids the disadvantages of what is known and which can be folded to be especially small, preferably can be carried as hand baggage in an aircraft or in a space-saving manner in a car and still can be individually adjusted to the child and is moreover characterized by simple production and handling.

This object is achieved with a stroller with a folding mechanism consisting of pivot joints according to the independent claim.

The stroller consists of a seat element, a seat back, a first mounting for at least one front wheel and a second mounting for at least two rear wheels, and a pushing device. Furthermore, it has a folding mechanism to which the seat element, the seat back and the first and second mounting are each attached on one side. All elements are attached to the folding mechanism such that they can be pivoted around it, the folding mechanisms having pivot joints for continuous pivoting of the individual elements.

The designations front and rear wheels establish neither the pushing direction of the stroller nor the direction in which the child is looking. It is for example conceivable that the pushing device can be swivelled such that the direction in which the child is looking can be chosen to be in the direction or opposite the direction in which the stroller is moving. Here those wheels which are located at the feet of the child are called the front wheels.

To produce the stroller, different materials in different combinations can be used. In particular, reinforced plastics, for example with stabilizing ribs or gas injection or with glass fiber filling, drawn or welded aluminum or steel sections, and foam cushions with fabric or synthetic fiber coatings are suitable for producing a child-friendly product.

The seat back can be made as a plastic shell with a fabric covering. But a seat back in which only the frame is shaped from rigid material is advantageous. The fabric covering can be attached to this frame and forms the actual seat back. In this way the stroller can be collapsed to be flatter. Moreover the fabric covering can be produced to be adjustable in depth using zippers or velcro fasteners or pushbuttons. Analogously the seat can also be produced as a fabric seat in a metal or plastic frame.

The mountings for the front and rear wheels can likewise be made only as a frame or as rigid shell.

Preferably the stroller has exactly two front and two rear wheels. Furthermore it is advantageous if at least the front wheels are attached to turn freely; this simplifies steering of the stroller.

The folding device has two basic positions. In the first position the stroller is in the operating position, in the second position it is collapsed.

The stroller can advantageously be fixed in its first position. One skilled in the art is familiar with many means for fixing how the stroller can be fixed in the operating position. For example, stops, clamps, catches or wedges can keep the elements in their position. Other means for fixing the stroller in the operating position are however likewise encompassed by this invention.

So that easy handling is ensured, there is preferably a release mechanism, by means of which at least two of the elements seat, seat back, first and second mounting or pushing device are released jointly or simultaneously from the operating position. Especially advantageously all elements are released jointly or simultaneously. In this case all elements can be released from the operating position with a handle and thus moved easily into the collapsed position.

In order to increase safety, it is advantageous if the release mechanism has to be actuated with two hands. The danger that the release mechanism will be actuated unintentionally, for example by another child, can be further reduced if a certain expenditure of force is necessary for actuating the release mechanism. For this purpose the release mechanism can be stabilized for example with a spring.

Especially preferably the release mechanism comprises a Bowden cable. In this way the release, for example a lever, can be attached to a location on the stroller which is easily accessible to an adult, for example to the top end of the seat back. Via the Bowden cable the force expended for release is routed to the means for fixing the stroller which are conventionally located on the joint itself.

In the collapsed position the seat element, the seat back and the first and second mounting are arranged preferably roughly parallel to one another, protruding from the folding device. Thus the stroller in the collapsed position is only half as long as in the operating position. The stroller in the collapsed position is moreover very compact due to the arrangement of the individual elements which is as parallel as possible, and compared to conventional strollers can be stored relatively flat and therefore in a space-saving manner.

In the operating position the elements are arranged roughly in a star shape around the folding device. Preferably the angles between the individual elements can be freely adjusted and the tilt of the seat and of the seat back can be individually matched. But it is also conceivable for each of the elements to be adjustable individually between a given number of positions and the angles to be thus incrementally variable.

In one preferred embodiment, the pivot joints of the seat elements, the seat back and the first and second mountings are arranged flush on the axis of rotation. This axis of rotation need not necessarily be made continuous; it can also consist of individual pivot joints as a geometrical product of several axes.

So that the stroller elements in the collapsed position are arranged roughly parallel to one another, the elements can be of varied size. For example, the mounting for the front wheels can consist of two braces between which the seat is located in the collapsed position. Alternatively or additionally, individual ones of the elements, for example the seat back, can be attached to the folding mechanism such that the fulcrum does not lie on the extension of the seat back, but is slightly shifted. This can be achieved for example by a cranked attachment of the elements to the pivot joint.

In one preferred embodiment the pivot joints of the individual elements have disks, disk sections or rotary levers which are pivotally mounted on a common axle. At least two of the disks, disk sections or levers are advantageously locked by a common locking arrangement, preferably with a common locking element, for example a wedge, especially by the wedge's being able to be inserted into a catch groove of the disk. The disks can all have the same diameter. It is likewise possible for individual ones of the disks or disk sections to have a narrow diameter, so that when the locking element is released they are released first. Alternatively the catch groove in one disk can be shallower than in another and a wedge can be changed accordingly in a step-like manner such that the disks are released in a given sequence.

One alternative locking element can be a clamping device which locks the disks, disk sections or levers. The clamping device can for example be arranged analogously to a bicycle brake in the shape of a horseshoe around the disks, disk sections or levers. When the elements are locked, the clamping device at least partially adjoins the disks, disk sections or levers. This can be promoted by the disks, disk sections or levers being provided with projections, for example bolts or pins, which fit into the clamping device.

To release the locking, the clamping device is opened. For a horseshoe-shaped clamping device this means that the opening is widened. In this way the diameter of the clamping device becomes larger, and the disks, disk sections or levers lose contact with the clamping device.

One advantage of the disk arrangement is also that individual ones of the elements can be attached to the disks so that the extension of the element does not run through the pivot of the disk. This corresponds to tangential attachment of the element to the corresponding disk. Tangential here is referenced only to direction, but does not establish the location at which the respective element is attached to the corresponding disk.

The tangential attachment is one preferred alternative or addition to the cranked attachment of the elements to the pivot joint and allows improved parallel alignment of the elements in the collapsed position of the stroller. Moreover a joint which consists of relatively large disks is more stable than a conventional pivot joint.

In another preferred embodiment the pivot joints of the different elements are arranged flush on two axes of rotation. This embodiment is especially advantageous because the elements in the collapsed position can be aligned almost perfectly parallel against one another. A version in which the elements are flush on the three axes of rotation is likewise conceivable.

Individual ones or all of the elements can be provided with stops for limiting the pivoting angle. In this way the pivoting motion proceeds in a controlled region. Unwanted folding of the elements in an unexpected and unmanageable direction is thus prevented.

Especially preferably the stops are dictated by a locking disk. This is a good idea when the elements are attached to rotary disks. Each of these disks can be provided with a pin which runs in a lengthwise groove of the locking disk. The lengthwise groove runs parallel to the periphery of the disk over an angle segment of the disk. So that stability of the locking disk is ensured, the lengthwise groove in the radial direction advantageously does not extend any farther than over half the radius.

The pivoting angle of the element is limited over the length of the lengthwise groove. If several elements should strike the locking disk, the rotary disks nearer the locking disk can have a lengthwise groove by which the pin of the outer disk is guided to the locking disk. In this way the pivoting angle of the outer disk is also influenced by the inner disk. The disks can all be guided in the same lengthwise groove of the locking disk. But it is also conceivable for the locking disk to have several lengthwise groove sections, each section guiding a pin. It is advantageous on these arrangements that the diameter of all disks can be chosen to be the same.

Alternatively, the outer disk at least in places can have a larger diameter than the inner disk. The pin of the outer disk can be guided past the inner disk and in a lengthwise groove of the locking disk which lies radially farther to the outside.

Another especially preferred embodiment of means for limiting the pivoting motion of individual elements is the wedging of the elements against one another. This can take place for example when the pin of a disk is guided in the lengthwise groove of an adjacent disk. For example, the disk to which the mounting for the rear wheel is attached can have a lengthwise groove. In this lengthwise groove a pin can be guided which is attached to the disk for the mounting of the front wheels. In this way the relative motion between the first and second mounting can be limited. This means that the two elements can be swivelled against one another only over a given angular range.

Of course the same principle can also be applied to other elements.

The pivoting motion of individual elements can also be limited especially easily by their being connected to flexible means. These flexible means can be bands or cords or also rods with at least one joint. This type of limitation of the motion is an especially good idea for the two mountings of the front and rear wheels because for example a carrying net can be placed in the connection of the two mountings.

Advantageously the stroller has other means for fixing it in the collapsed position. These means can have catch projections, clamps, belts or other elements known to one skilled in the art. By fixing the stroller in the collapsed position it can be easily and safely transported. This is especially important when the stroller is to be carried by hand.

In one preferred exemplary embodiment, projections are attached to the seat back of the stroller. These projections support the stroller in the collapsed position so that the stroller can stand upright. The stroller elements arranged in parallel then stand perpendicularly from the ground. Moreover the projections can also be advantageously used in the operating position of the stroller, for example umbrellas, shopping bags, coats, etc. can be hung on them. It is also possible for accessories for the stroller to be attachable to it, for example a sunshade or a holder for a drinking bottle.

Preferably a footrest is attached to the first mounting. This enhances comfort and safety for the child.

The pushing device can be attached to the seat back. It is likewise conceivable for it to be attached directly to the folding device and for it likewise to be able to swivel around it. It is advantageous if the pushing device can be changed in its length, for example by its being attached to rails or to telescoping tubes. Alternatively the device can also be attached to the seat back to be able to pivot by up to 180°. Pivoting and/or adjustment of the length makes it easier for individuals of different sizes to comfortably push the stroller.

A pushing device which can be pivoted by 180° can moreover be connected to the release mechanisms for releasing the stroller from the first position. In one especially advantageous version the release of the means for fixing the stroller is triggered only by pivoting of the pushing device. This can take place for example by a Bowden cable being connected to the sliding device via a shaft. Moving the sliding device tensions the Bowden cable and releases the fixing of the stroller. The pushing device is advantageously held in position during operation in this exemplary embodiment by other means for fixing.

In one possible embodiment the elements are arranged in the collapsed position such that the bottom of the seat element and the mounting of the front wheels form the outer sides of the stroller. It is advantageous therein that the seat surface and the inside of the seat back are not so heavily exposed to ambient influences and remain rather clean. It is especially advantageous if the seat element has an extension which can be folded out or telescoped so that the length of the seat surface in the folded-out or telescoped state corresponds to the length of the seat back. Thus the two surfaces are protected over their entire extension.

Alternatively the top of the seat and the inside of the seat back in the collapsed position of the stroller can form the outer sides. In this connection, the disadvantage is that the seat surface of the child is more easily dirtied. But it is advantageous in this arrangement that the stroller is especially easily collapsed. After release of the fixing, the seat and the seat back fold onto the mountings of the front and rear wheel, while the latter are preferably still in the operating position. Thus the stroller is already half collapsed until it must be raised the first time.

In order to protect the seat surface and the seat back against dirt, protective coverings for the stroller can be offered.

The stroller can be adjusted especially advantageously in the operating position between a reclining position and a sitting position. The sitting position corresponds to the aforementioned, roughly star-shaped arrangement of the individual elements. In the reclining position the seat back can be moved into a roughly horizontal position. The extension of the seat is swivelled or pulled out and is used as an additional footrest for the reclining child. In particular, this extension can be provided with a fixed or folding stop which stabilizes the feet of the child down.

Preferably at least one carrying handle is attached laterally to at least one of the elements; this facilitates transport of the collapsed stroller.

Alternatively there can also be a carrying handle in the transverse direction of the stroller. In the embodiment in which the seat surface and the inner side of the seat back form the outer sides of the collapsed stroller, for example there can be a carrying handle between the seat and the seat back which appears when the stroller is collapsed. This carrying handle is then located roughly on the axis of rotation of the folding mechanism. In the operating position such a carrying handle is hidden under the seat. This is aesthetically advantageous. When being collapsed, this carrying handle facilitates the final collapse of the stroller. When the seat and the seat back have come to rest on the two mountings of the front and rear wheels, the carrying handle is free in between. The stroller can then be lifted on the carrying handle, the mountings moving together until they adjoin. The stroller is then in the collapsed position.

The stroller can be folded up especially flat when the front and/or rear wheels of the stroller are attached to be able to pivot by roughly 90° against the stroller. This is especially advantageous when the wheels have a large diameter.

But it is also conceivable for the wheels to be positioned laterally slightly beyond the mountings. Here it is especially advantageous if the two mountings are not equal in length from their axis of rotation to the wheel suspension, for example the one for the rear wheels is somewhat shorter than the one for the front wheels. The mountings can be adjoin one another. Since the wheels go beyond the mounting, they do not hinder movement.

If the difference in length of the two mountings is greater than the radius of the wheels, in the lengthwise direction of the mountings they have room next to one another, the mountings are not stopped by the wheels, but by the other elements.

The front and/or rear wheels can be arranged such that in the folded together position they project over the remaining elements. When the stroller is being transported they can thus be used for pulling or pushing the stroller.

To protect the stroller in the collapsed position against dust, dirt, moisture or damage, protective coverings can also be supplied. They should reasonably overlap at least the corners. The protective covering can also enclose the entire stroller; this is suitable when it is to be stored for a longer time. For transport, protective coverings which leave at least one carrying handle exposed are more advantageous. For heavier strollers it is advantageous for the front and/or rear wheels and the pushing device to be exempted from the protective covering so that the stroller can be pushed or pulled as a trolley trunk.

The invention is detailed below using figures and various exemplary embodiment.

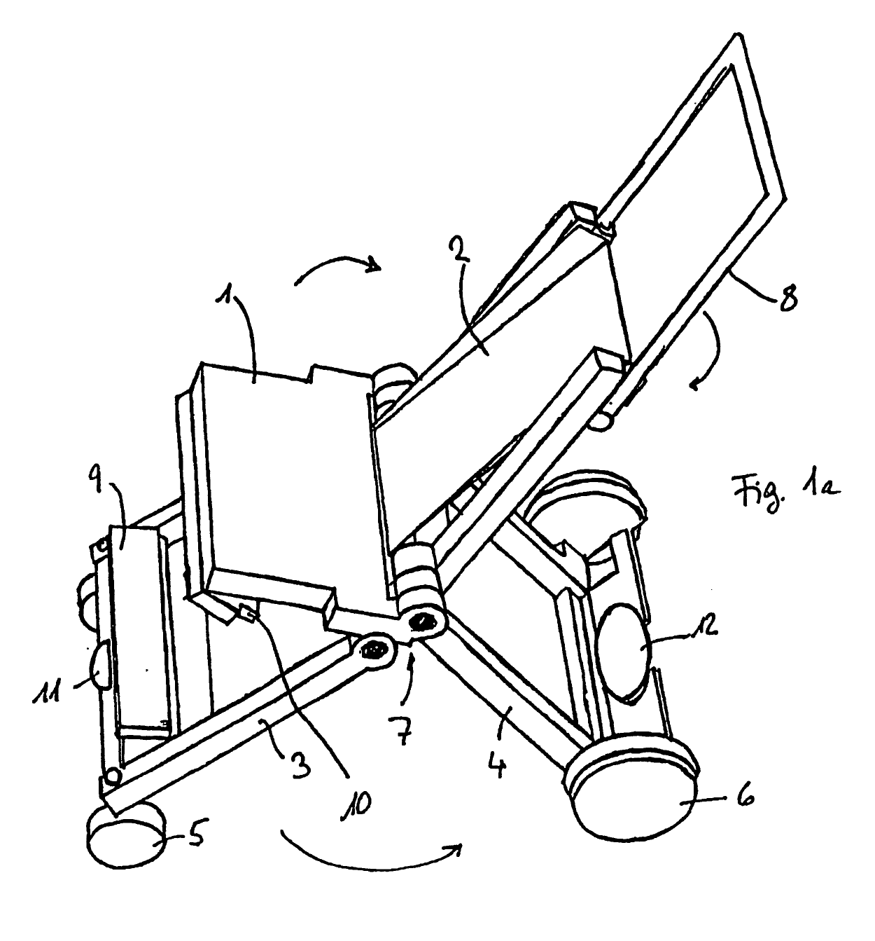

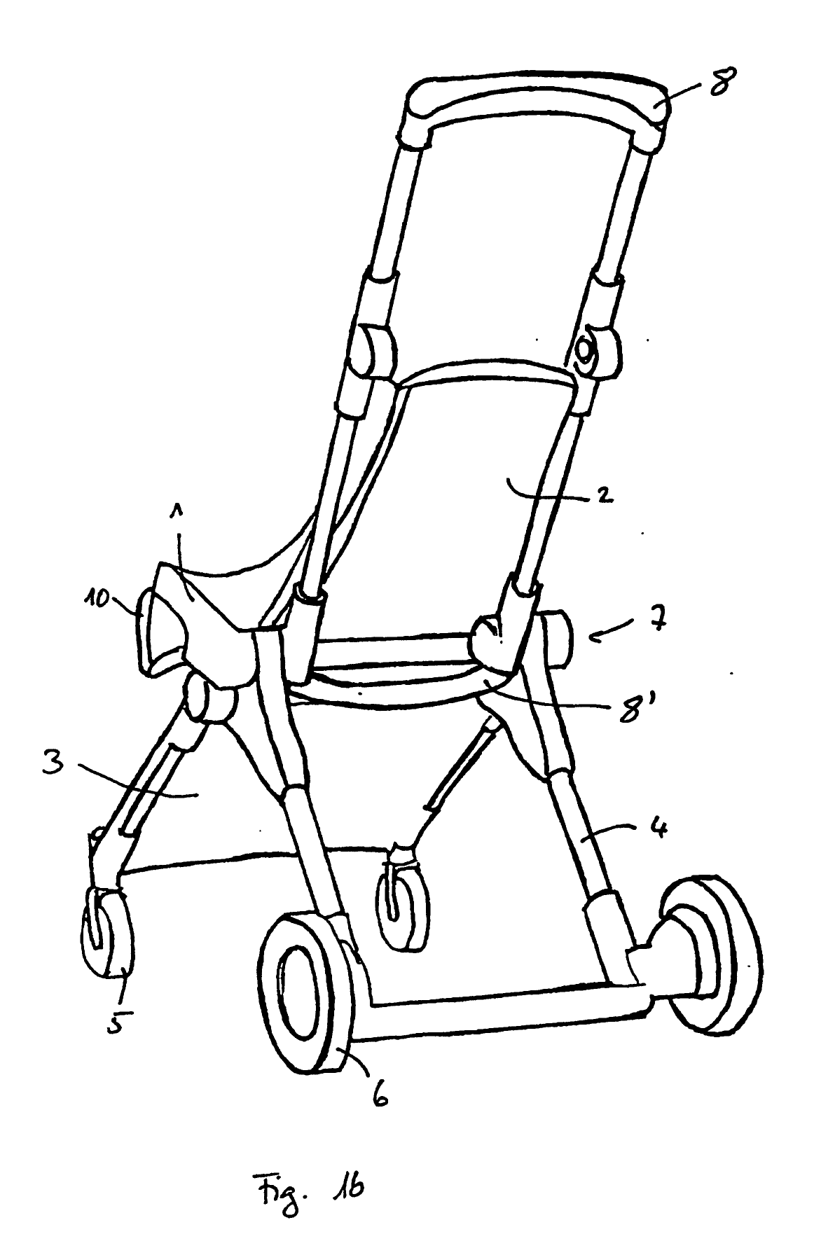

FIG. 1a shows a stroller as claimed in the invention in the operating position;

FIG. 1b shows one alternative embodiment of a stroller as claimed in the invention in the operating position,

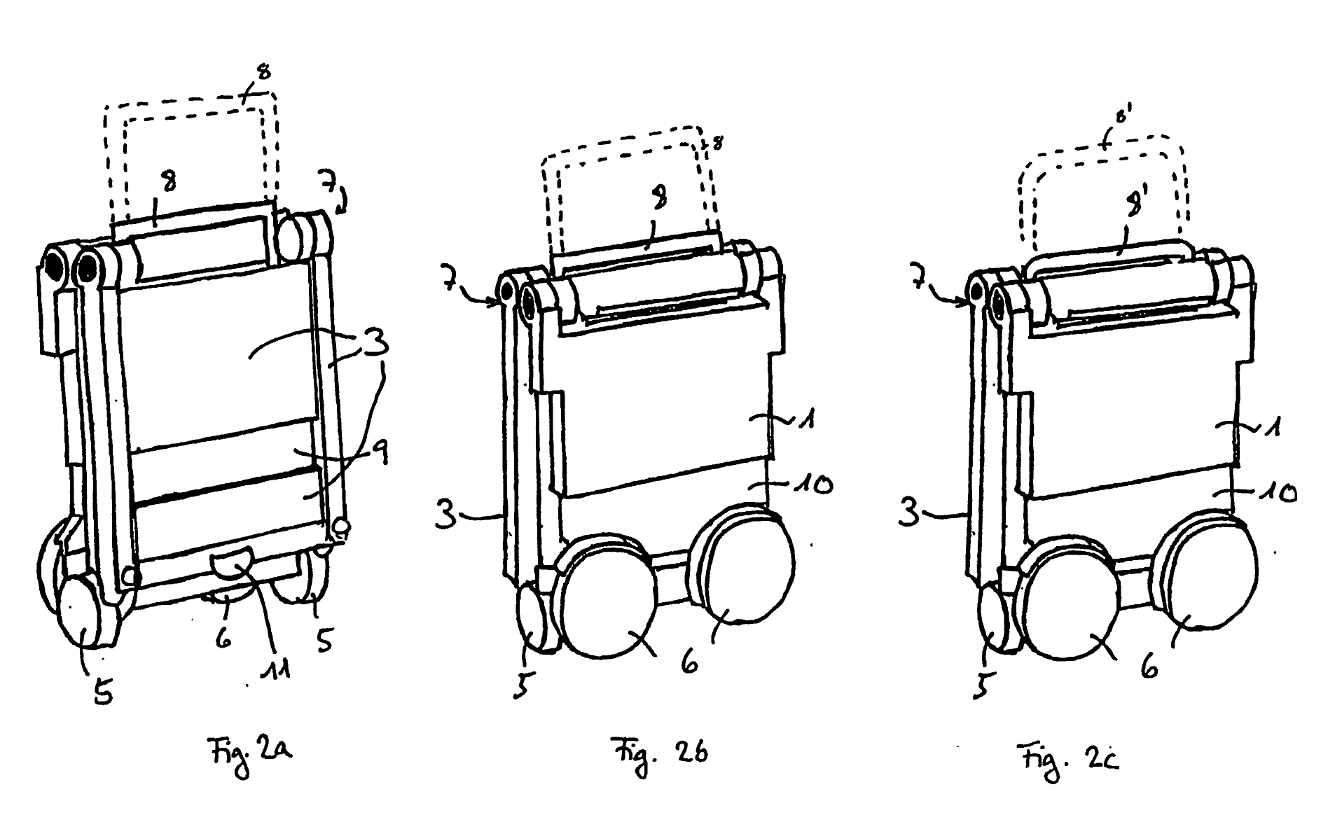

FIGS. 2a, 2b show a stroller as shown in Figure la in the collapsed position in two views,

FIG. 2c shows a stroller as shown in FIG. 1b in the collapsed position,

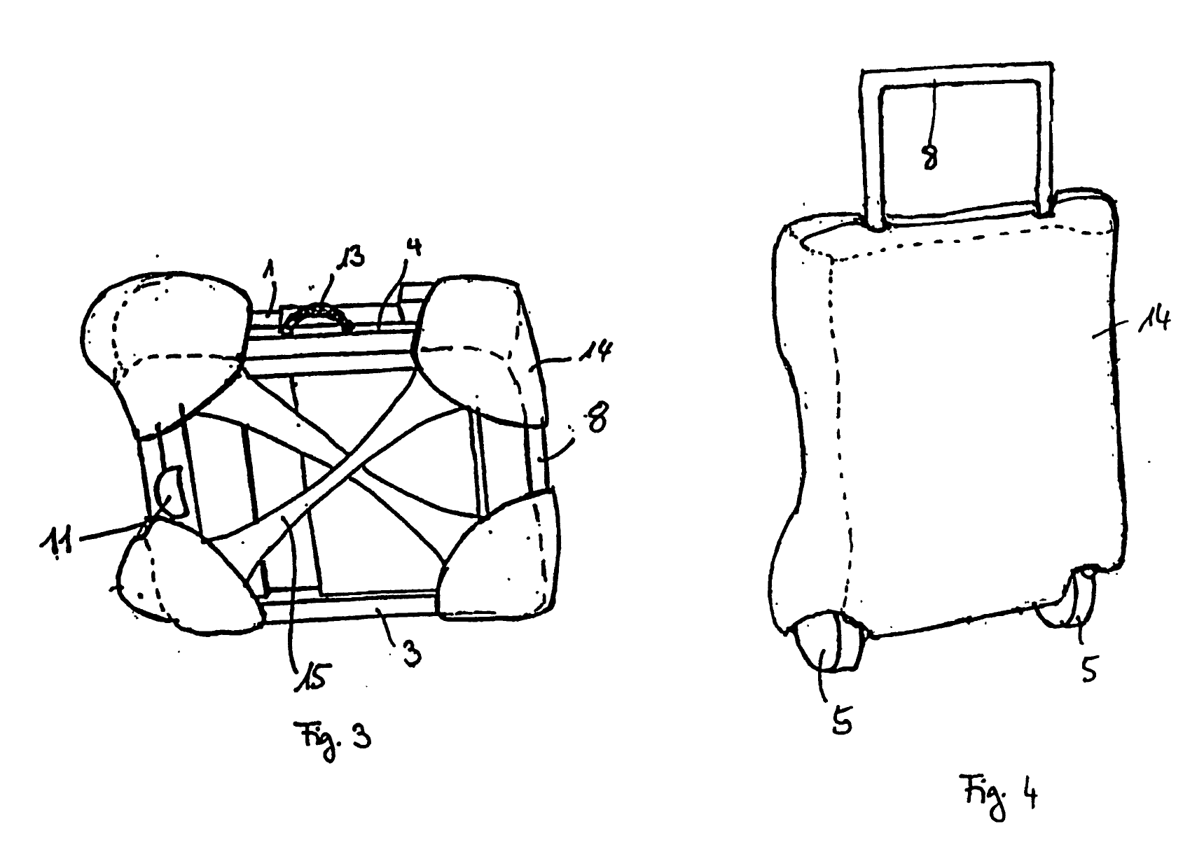

FIG. 3 shows a collapsed stroller with protective coverings on the corners,

FIG. 4 shows a collapsed stroller as shown in FIG. 1a with a protective covering, which can be pulled as a trolley trunk,

FIGS. 5a-5d show a schematic of the folding of the stroller as shown in FIG. 1a out of the operating position into the collapsed position,

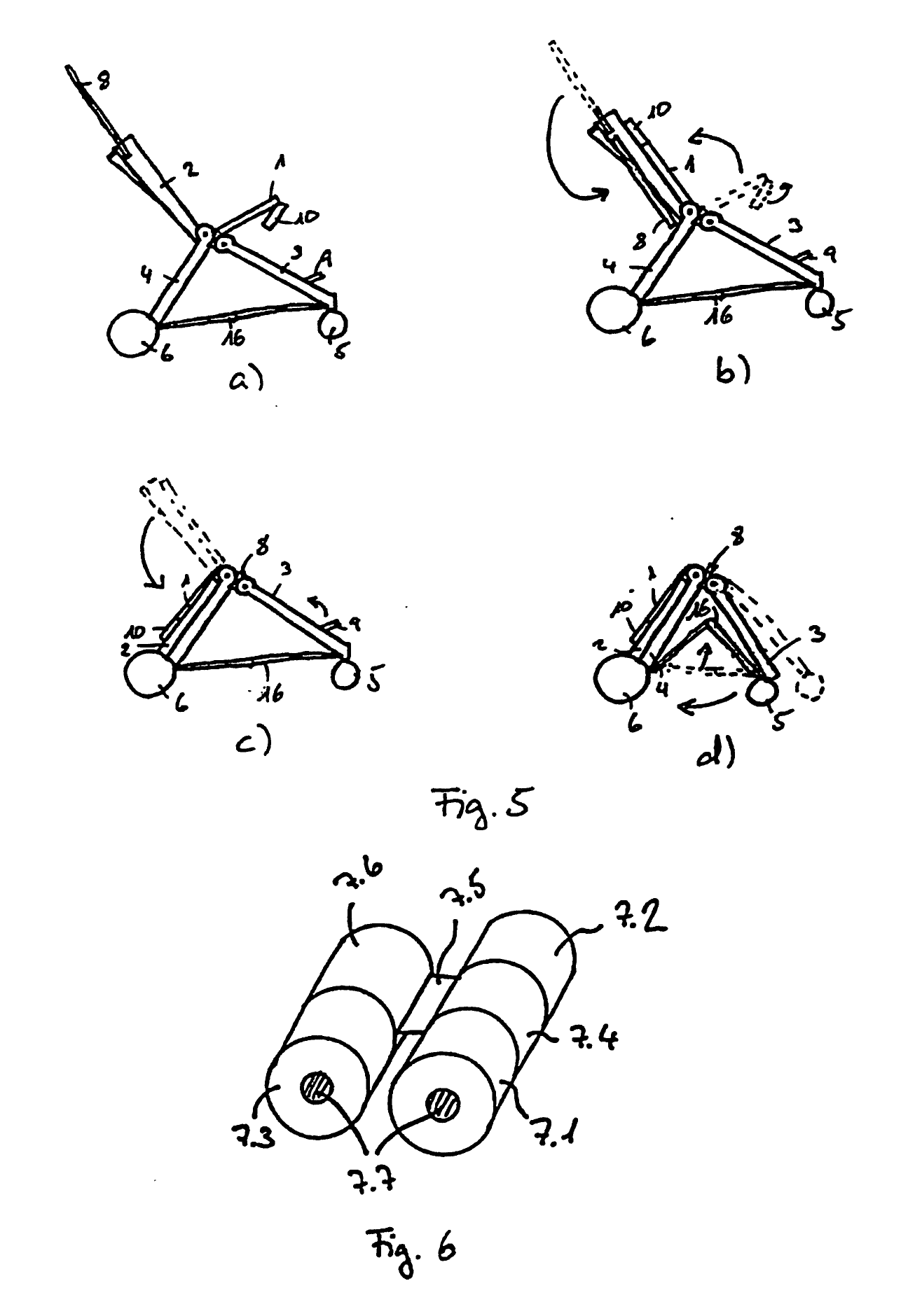

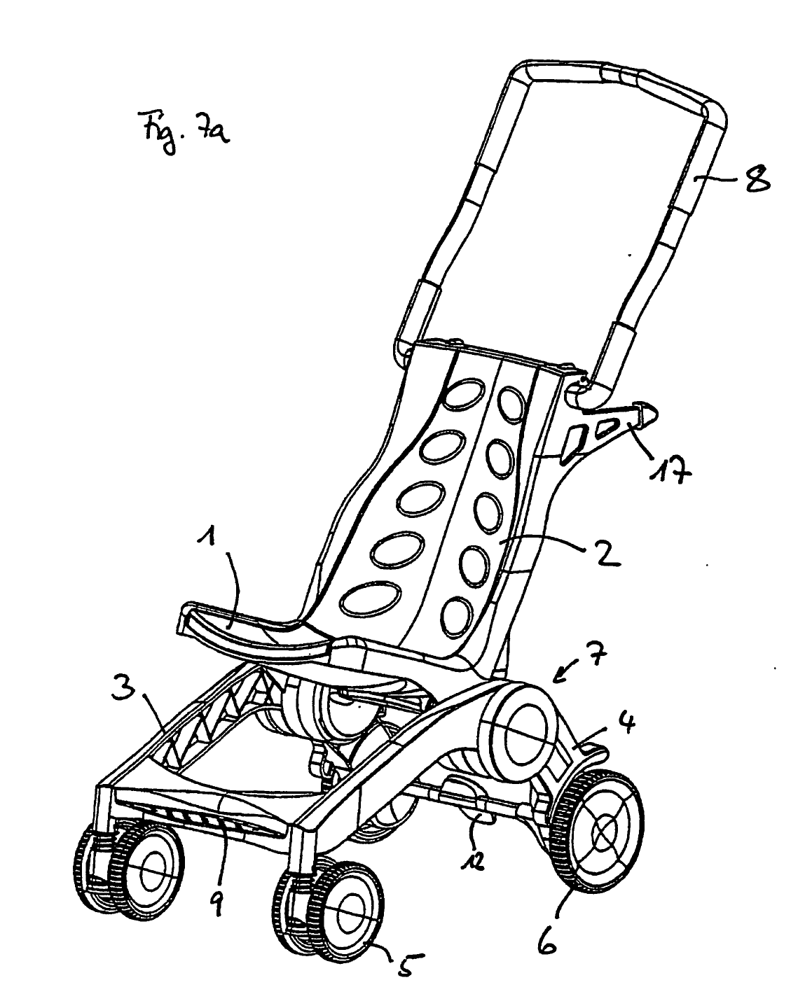

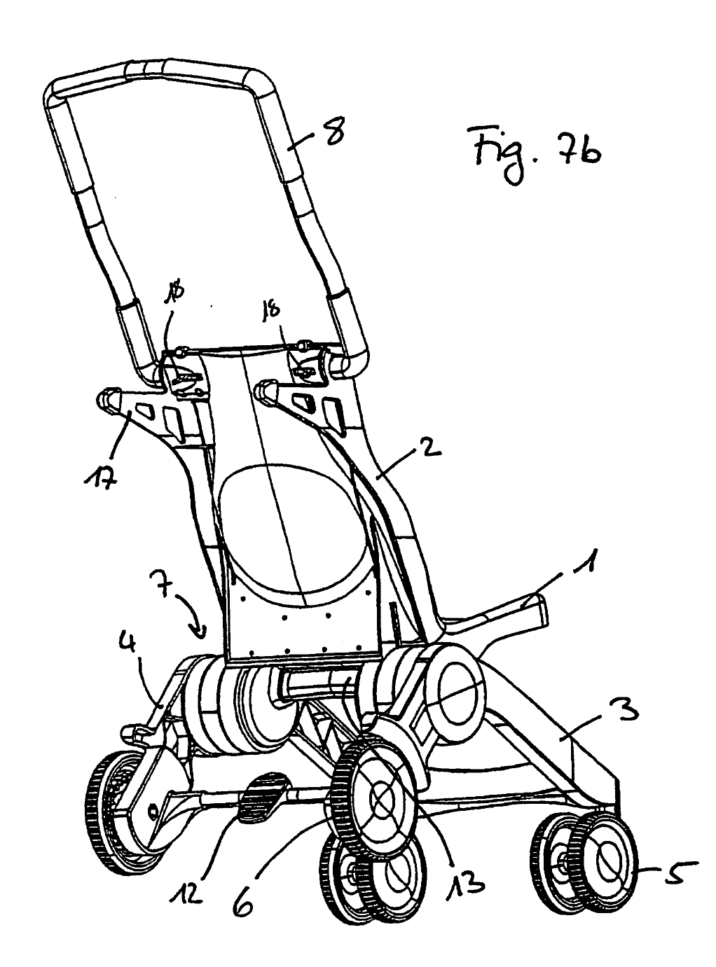

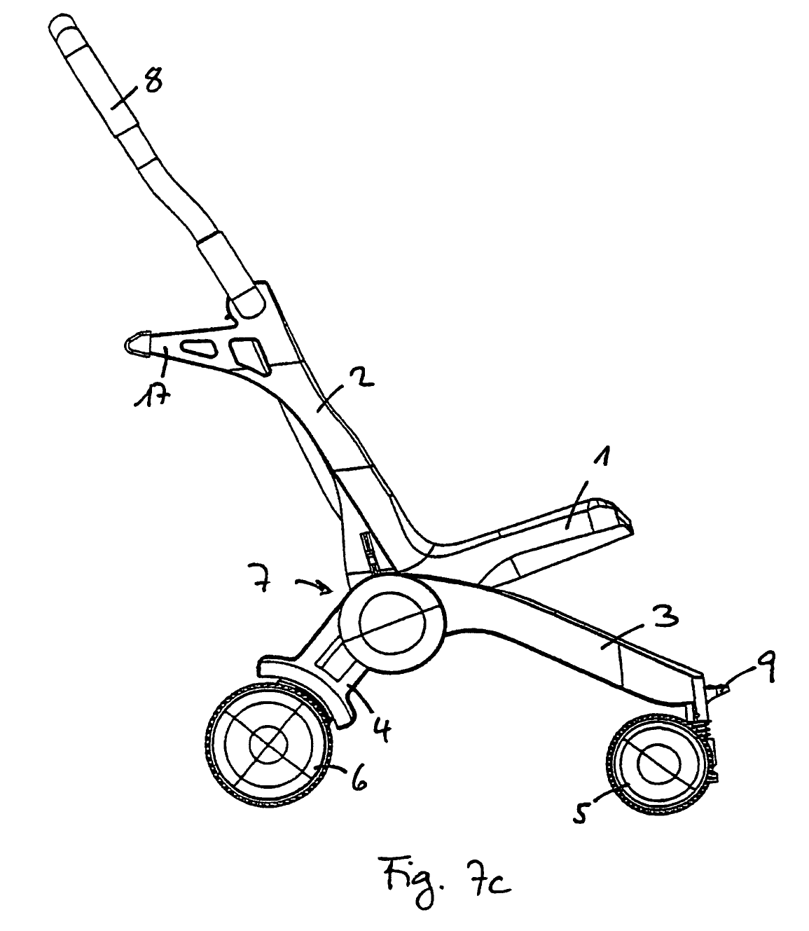

FIG. 6 shows a partial view of the folding device of a stroller as shown in FIG. 1a,

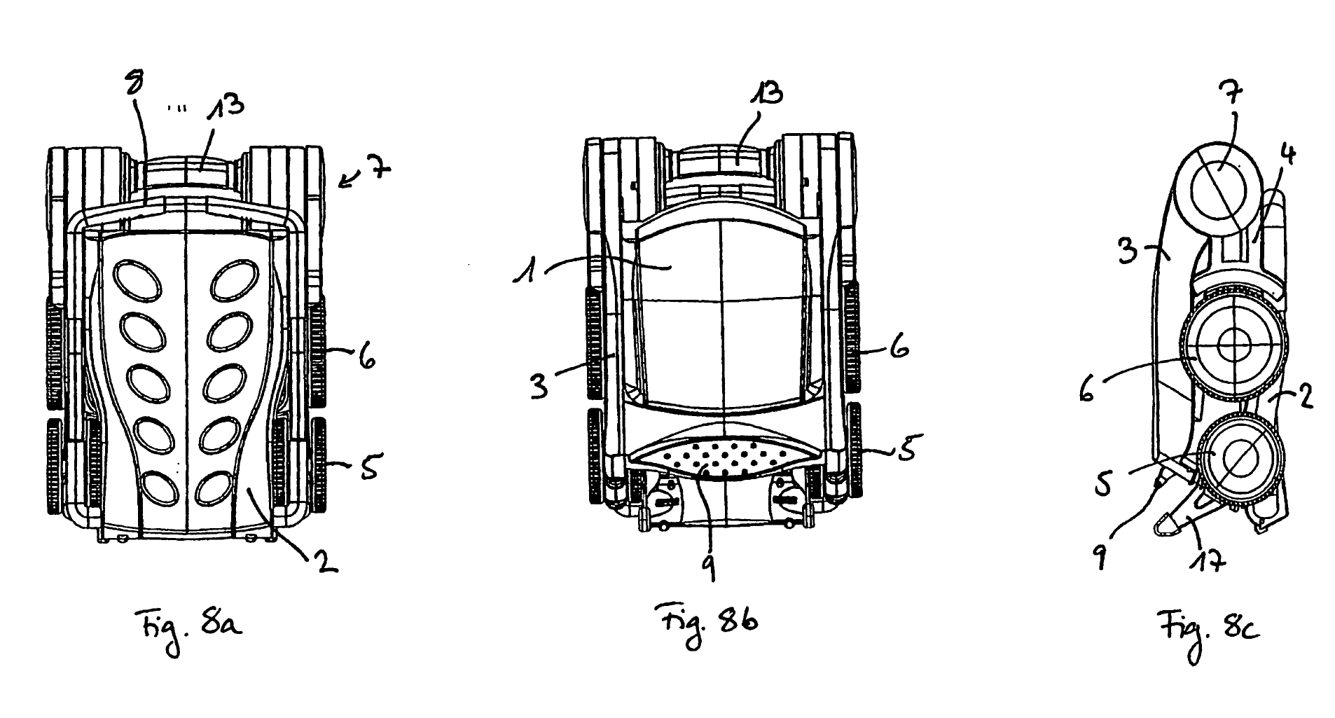

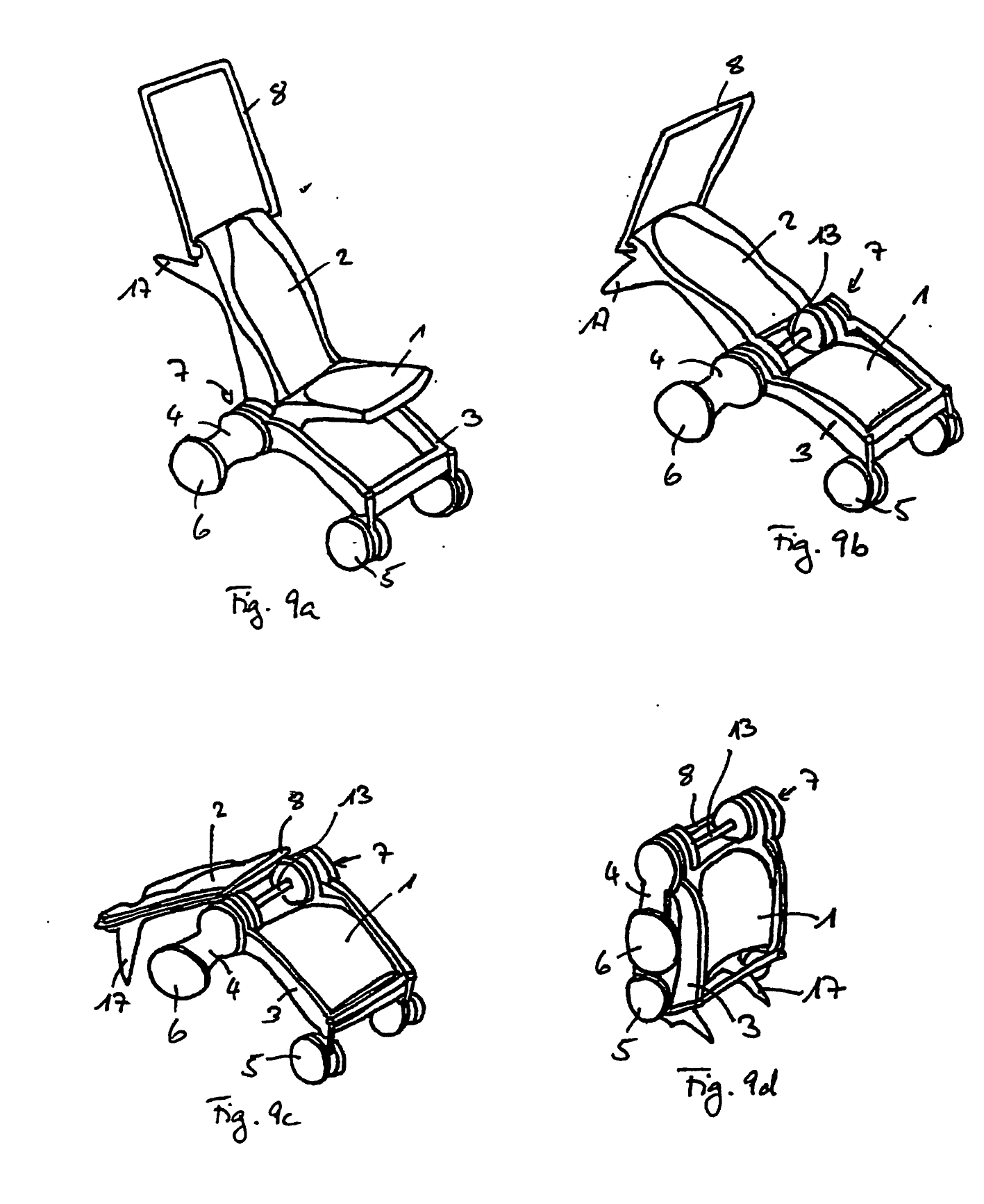

FIGS. 7a, 7b shows another embodiment of the stroller as claimed in the invention in the operating position in two views,

FIG. 7c shows the stroller as shown in FIGS. 7a and 7b in a side view,

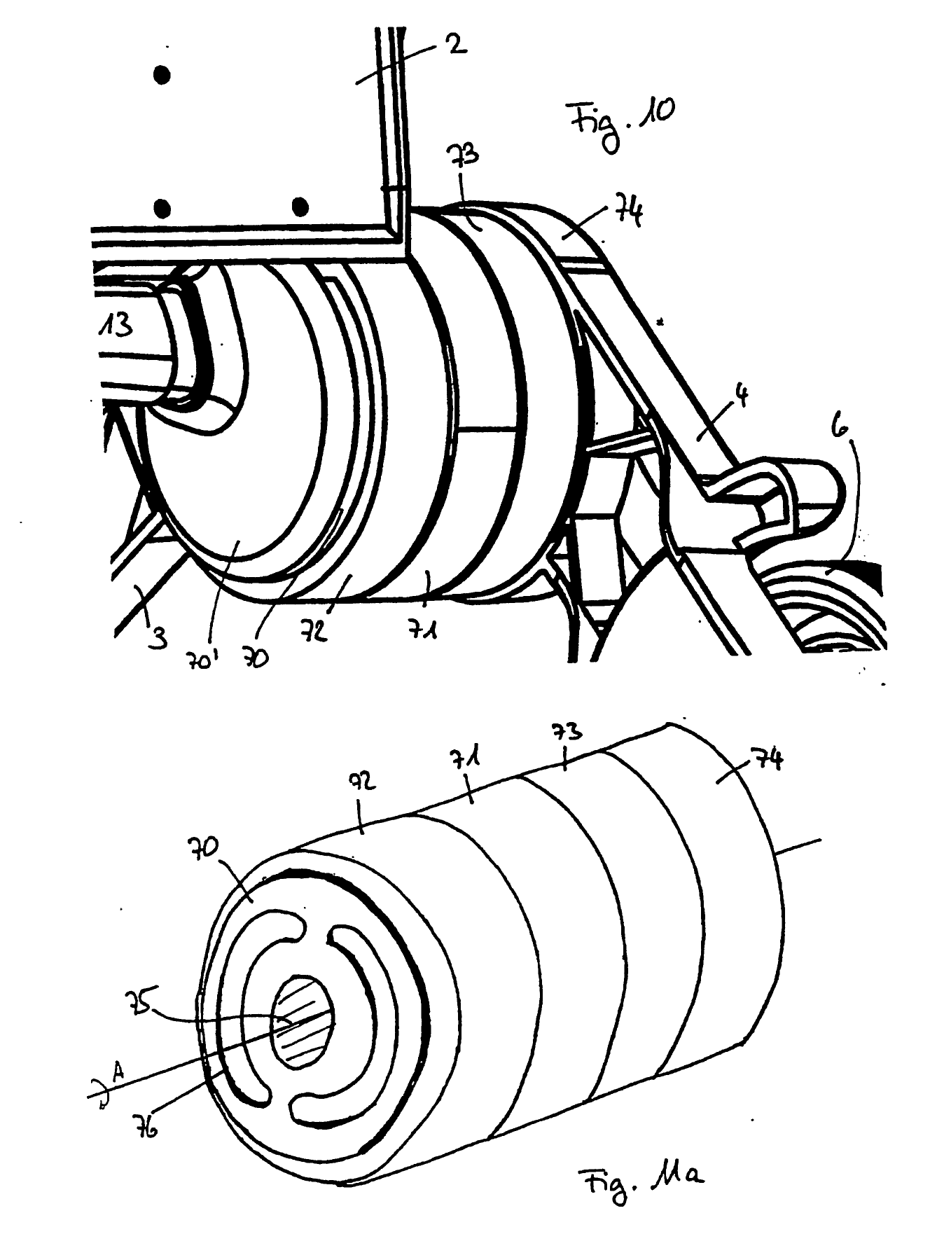

FIGS. 8a, 8b show the stroller as shown in FIGS. 7a and 7c in the collapsed position in two views,

FIG. 8c shows the stroller as shown in FIG. 8a and 8b in a side view,

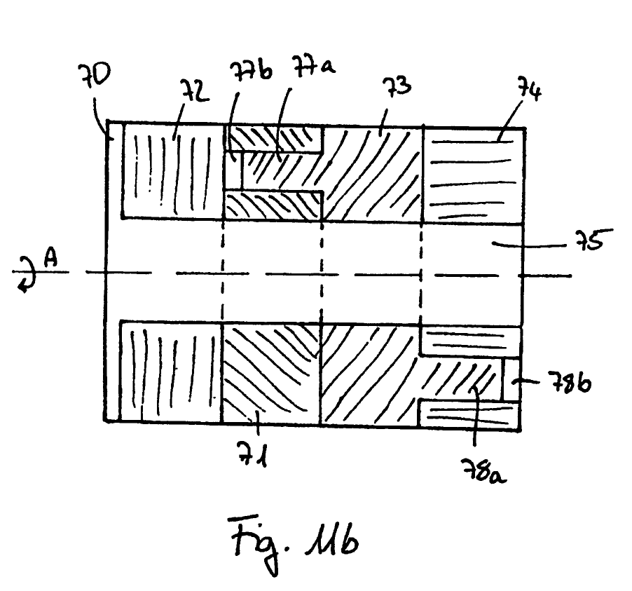

FIGS. 9a-9d show a schematic of the folding of the stroller as shown in FIGS. 7a-7c, 8a-8c into the collapsed position,

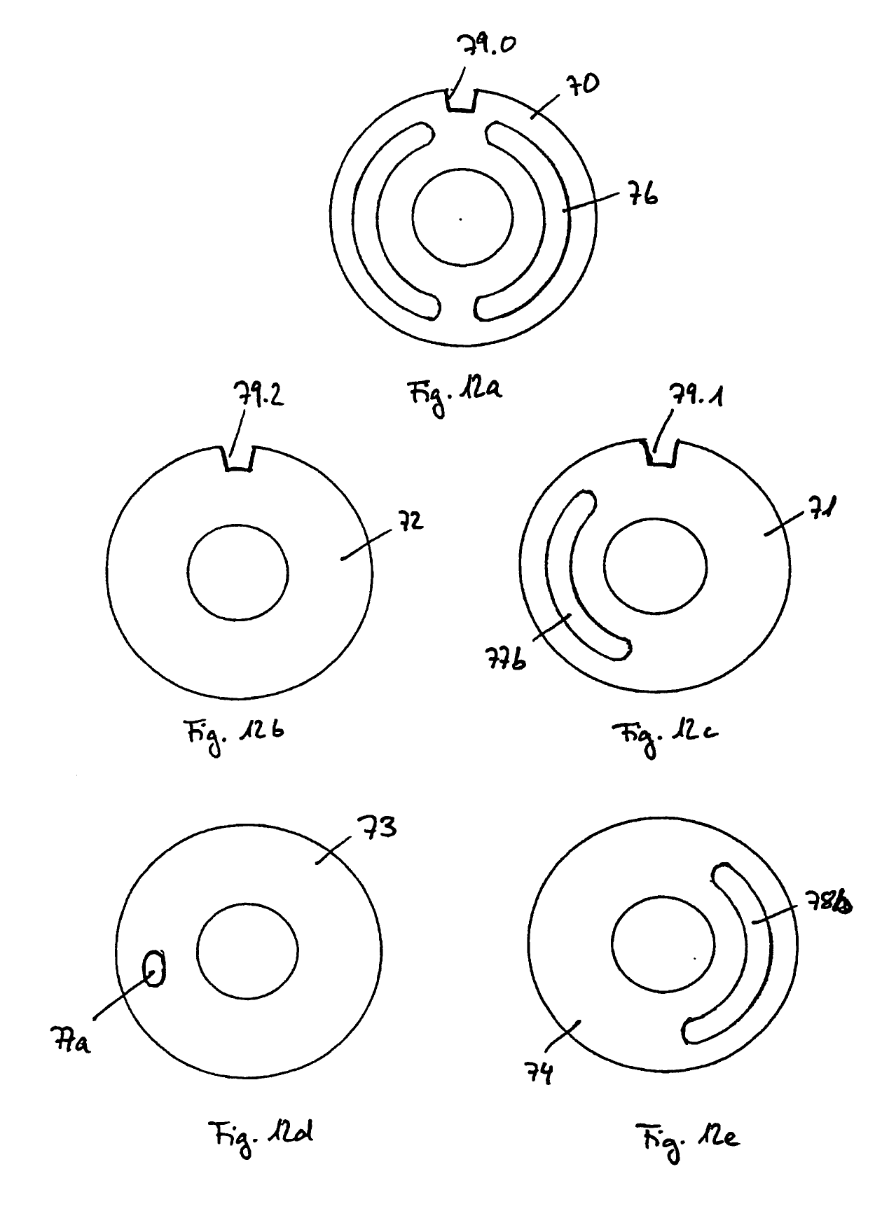

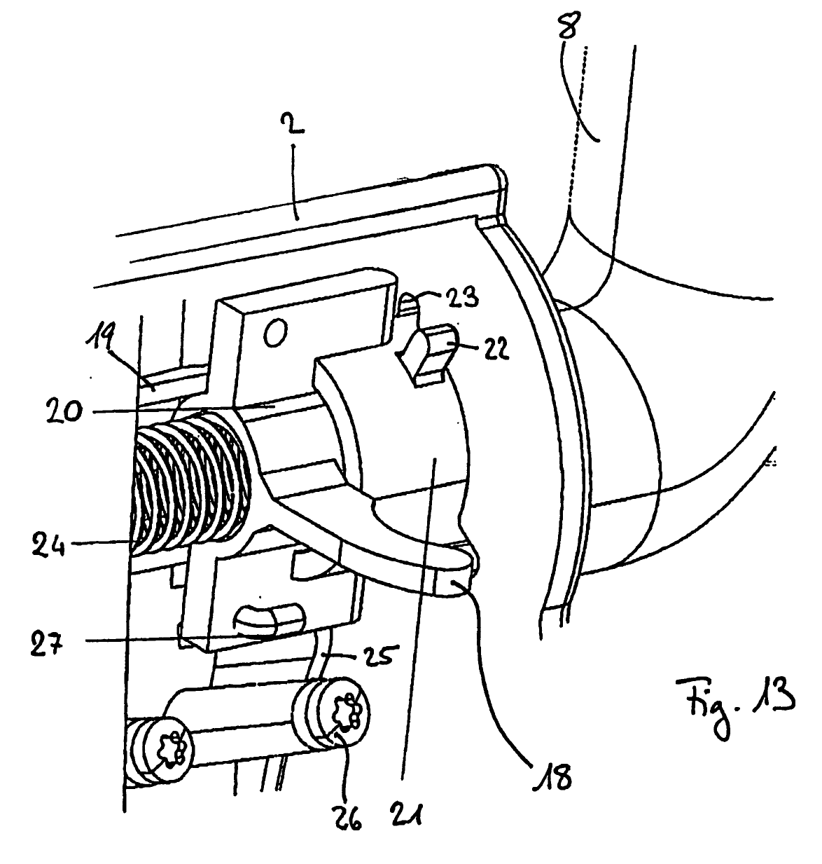

FIG. 10 shows an enlarged extract of the folding joint of a stroller as shown in FIGS. 7a-7c,

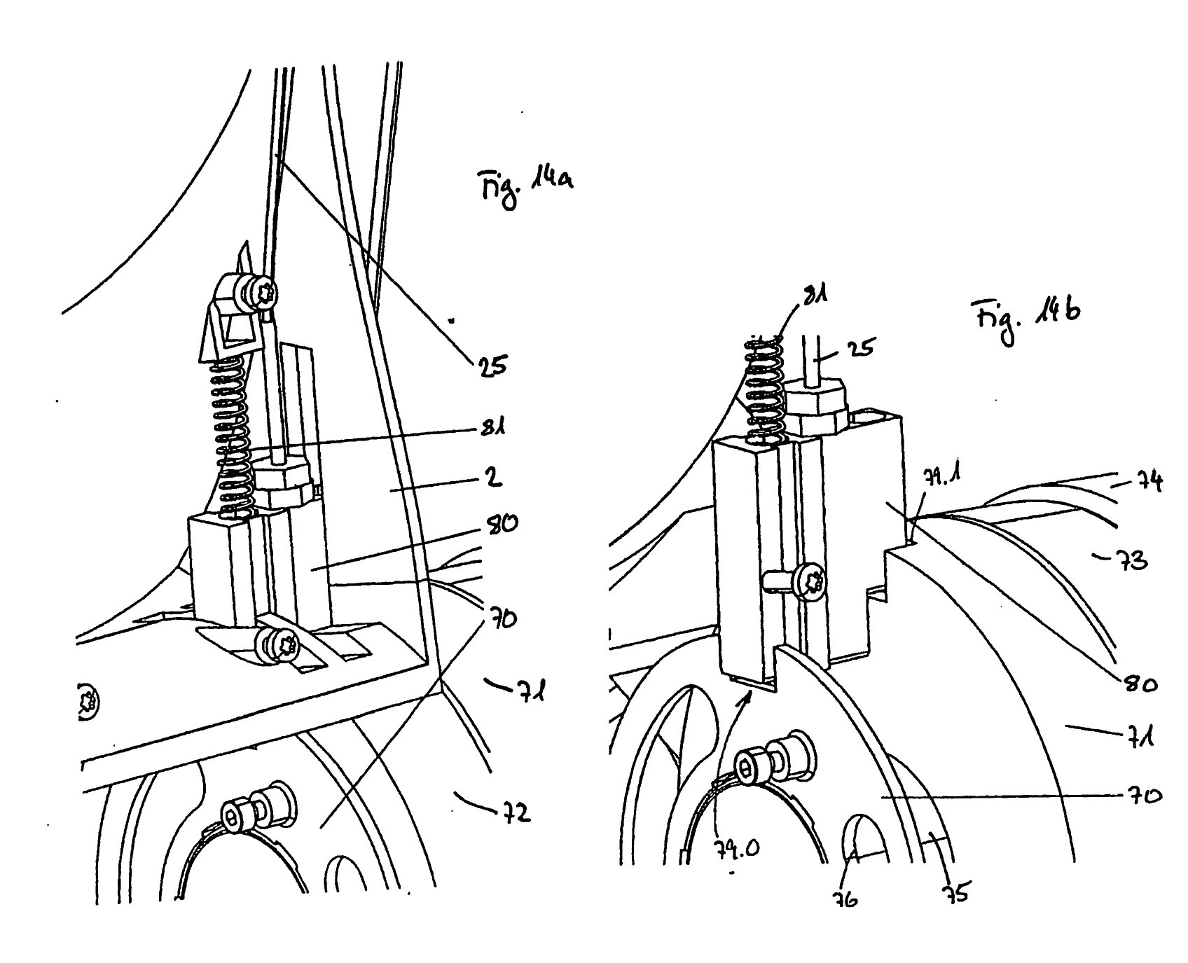

FIG. 11a shows a schematic of the folding device of a stroller as shown in FIGS. 7a-7c, 8a-8c in a perspective,

FIG. 11b shows a section through the axis A as shown in FIG. 11a,

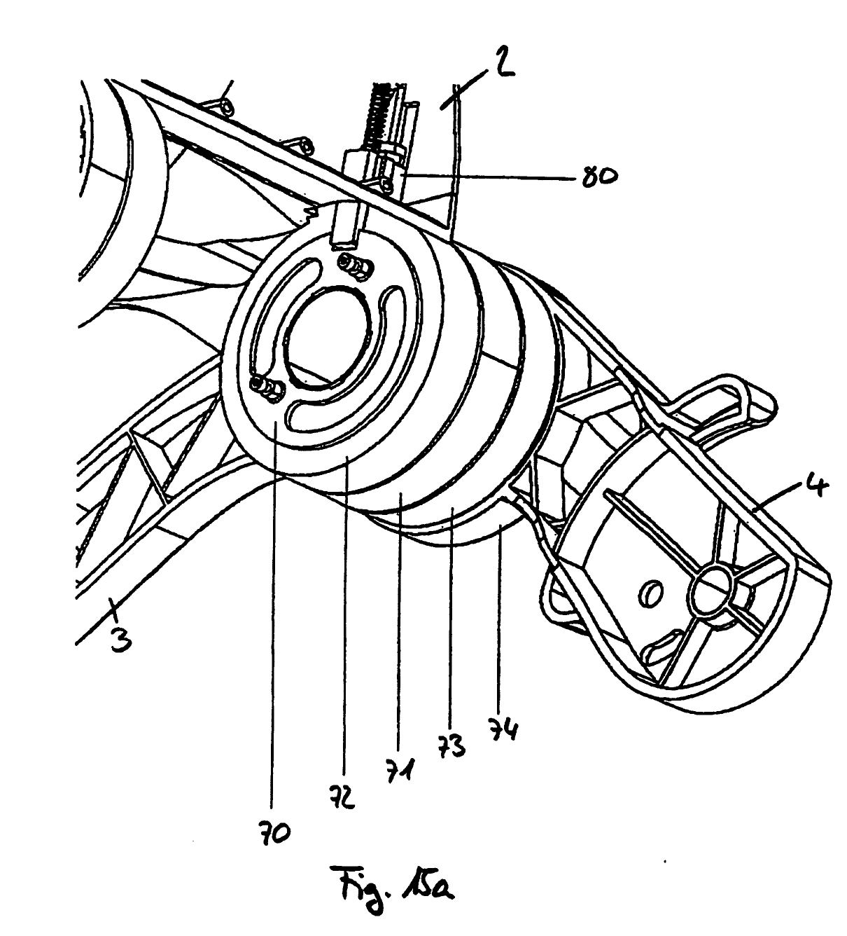

FIGS. 12a- 12d show elements of the folding joint in a top view,

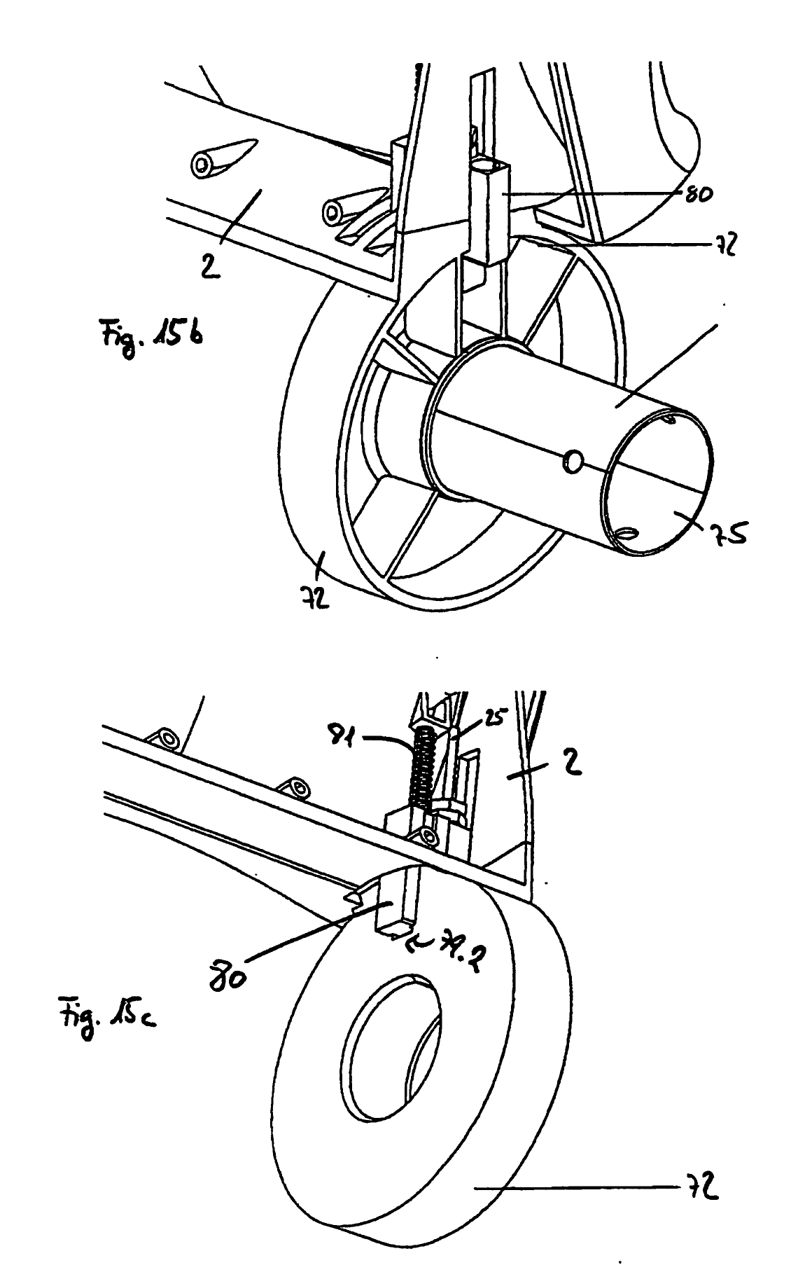

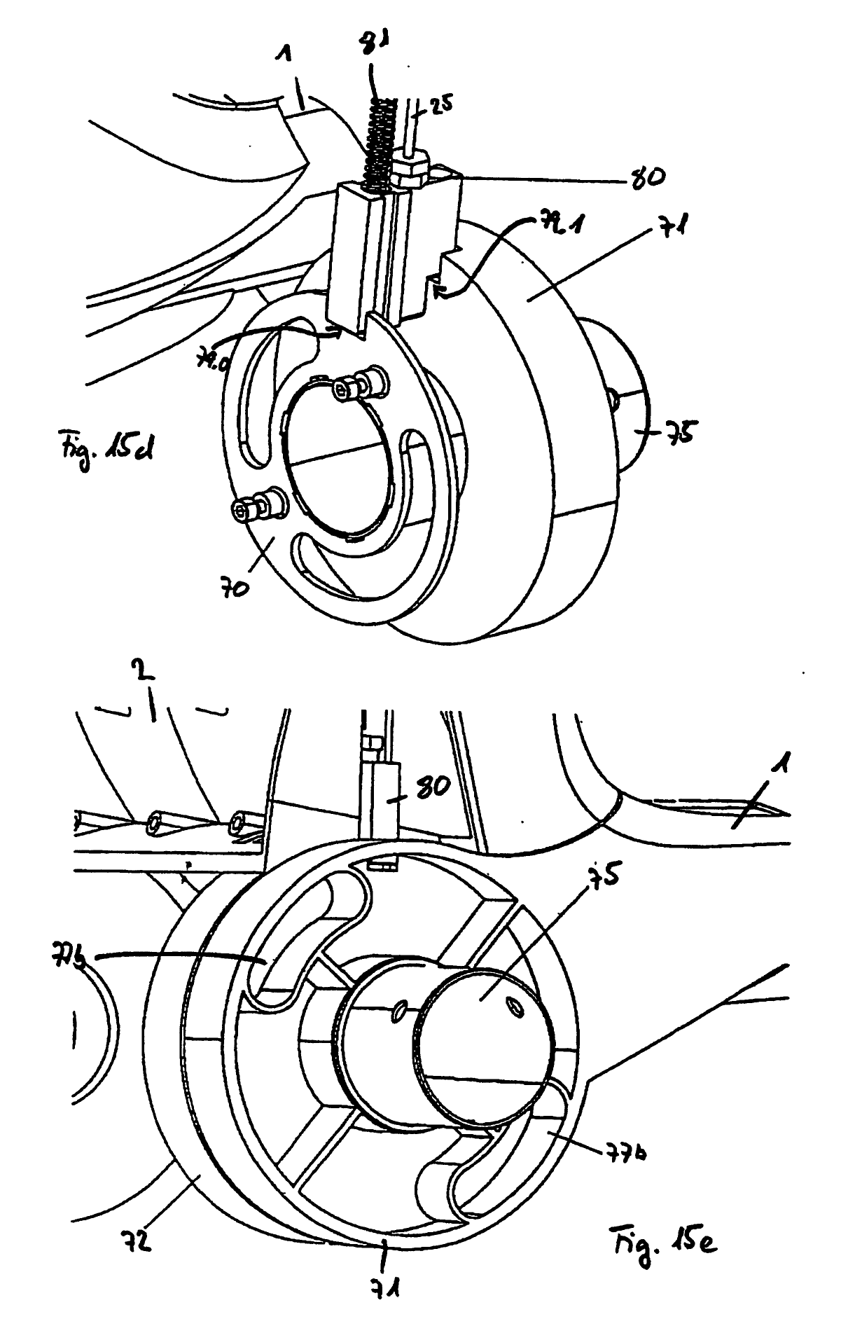

FIG. 13 shows a perspective of the release mechanism of a stroller as shown in FIGS. 7a-7c, 8a-8c,

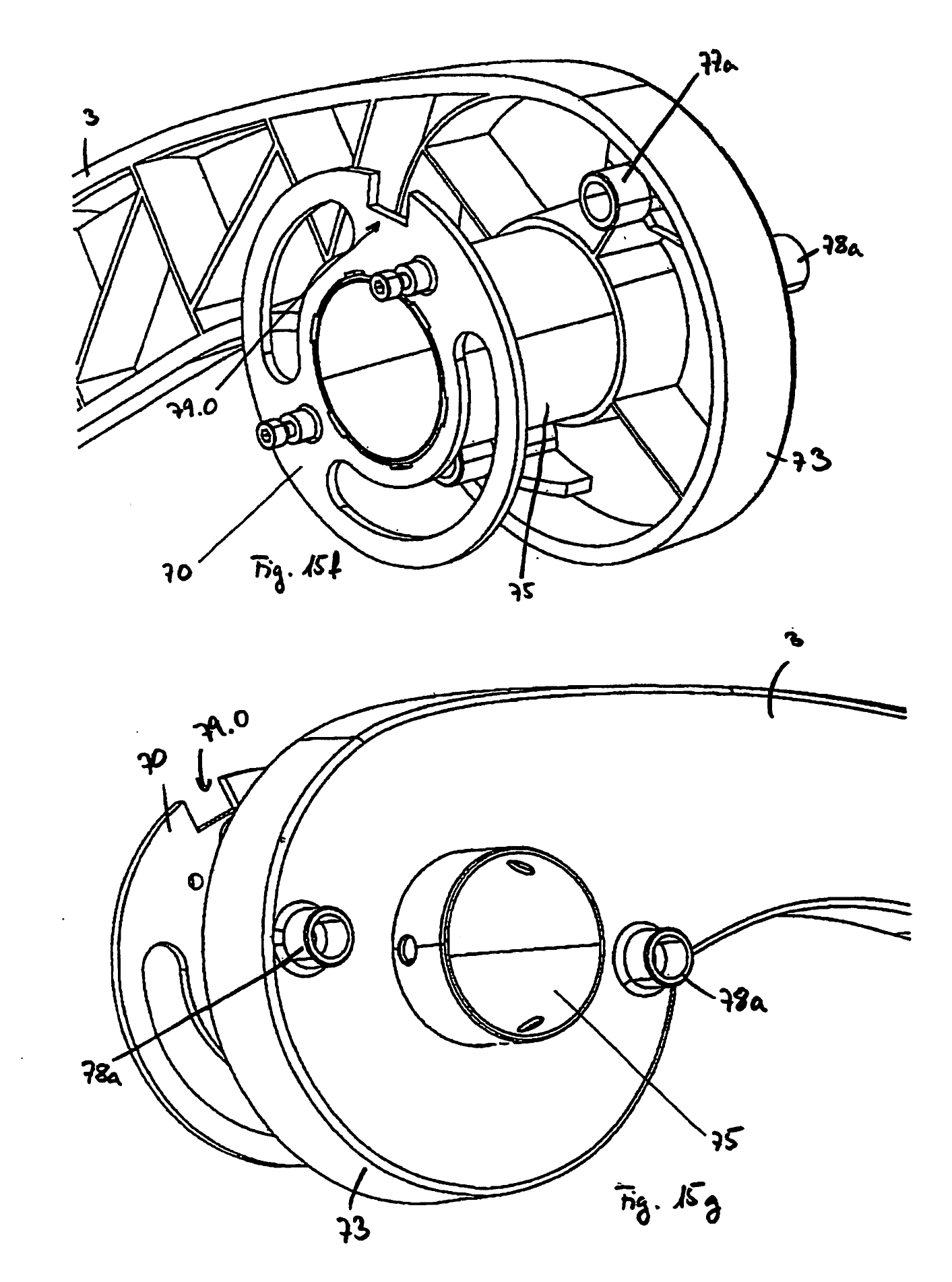

FIGS. 14a, 14b show a perspective of the fixing of the folding device in two views, and

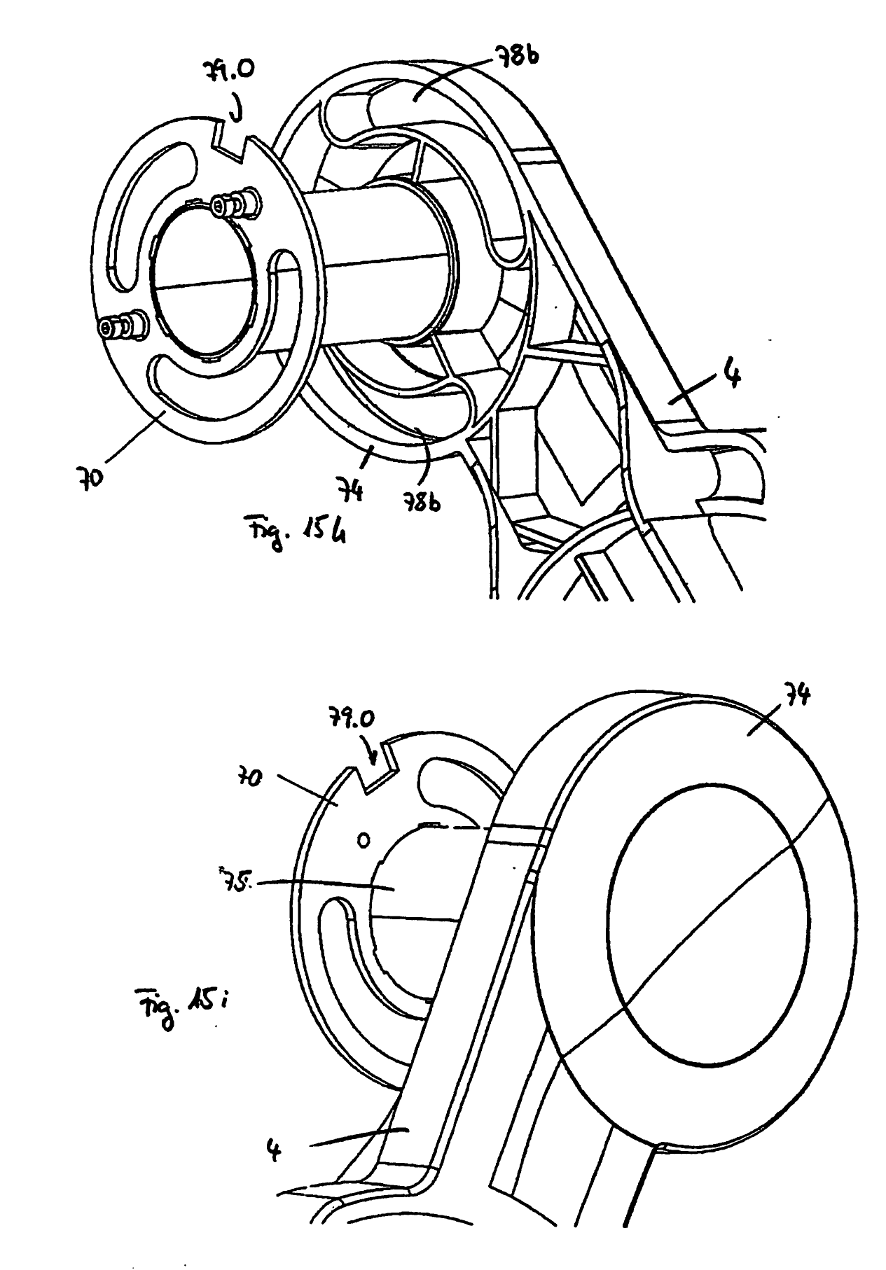

FIGS. 15a- 15i show detailed perspectives of the elements of the folding joint as shown in FIGS. 7a-7c.

FIG. 1a shows the collapsible stroller in the operating position. The seat element 1, the seat back 2, the first mounting 3 for the front wheels 5 and the second mounting 4 for the rear wheels 6 are arranged roughly in a star shape around the folding device 7. The pushing device 8 is attached to the seat back 2. A footrest 9 for the safety and the comfort of the child is attached to the first mounting 3. This footrest can be folded up for collapsing. An extension 10 which can be folded out and which is folded up in the collapsed position of the stroller is attached to the seat element 1. If the stroller is moved into the reclining position, the extension is used as a footrest for the child. A closure 11 which fixes the stroller in the collapsed position is attached to the first mounting 3. Moreover a brake 12 with which the rear wheels of the stroller are blocked is attached to the second mounting 4. Alternatively the brake 12 can be attached to the pushing device 8 via cable pulls with handles (not shown) and can be operated by hand.

The movements of the individual elements during adjustment are indicated with the arrows.

The wheels 5, 6 or the mountings 3, 4 of the stroller can be supported via springs (not shown) which, when travelling, capture impacts which occur due to irregularities in the path. Moreover the two mountings 3 and 4 can be connected to transverse connections 16 (shown in FIG. 5); this stabilizes the stroller and protects it against unwanted collapse. This is especially advantageous on uneven paths or when crossing streets with curbstones. A carrying net (not shown) can be attached to these transverse connections 16.

A sunshade and/or umbrella (not shown) which can be folded up preferably like a fan can be attached to the seat back 3 or on the pushing device 8. Moreover, for reasons of safety a belt system (not shown) can be attached to the seat back 2 and to the seat element 1 with which the child is secured in the stroller while moving.

FIGS. 2a and 2b show two views of the stroller as shown in FIG. 1a in the collapsed position. In this version the seat element 1 and the first mounting 3 form the outer sides of the stroller. The mounting 3 is made as a reinforced shell so that the stroller has stable outer sides in the collapsed state. The rear wheels 6 are located in the wheel boss caps (not shown) which are folded by 90° against -the stroller. The footrest 9 is pivotally mounted and in the collapsed state is turned against the stroller. In this way the entire stroller is very compact and stable. The lock 11 prevents the stroller from opening in an unwanted manner. In this embodiment the pushing device 8 is pivotally attached to the seat back 2 such that it is turned by 180° against the seat back when the stroller is collapsed and is suited for carrying the latter. The front wheels 5 in the collapsed position project over the other elements. The stroller can therefore be pushed or pulled even in the collapsed position. This can be done especially easily when the pushing device 8 can be adjusted in its length. This is indicated by the broken lines.

As shown in FIG. 1b, the pushing device 8 can be additionally equipped with a counterpart 8′ on the bottom end. In the collapsed state this counterpart 8′ can be used to carry and/or push or pull the stroller.

The counterpart 8′ can be made telescoping analogously to the pushing device 8; this is advantageous when the stroller is pushed or pulled in the collapsed state (see FIG. 2c).

In the embodiment as shown in FIG. 1b, the counterpart 8′ in the collapsed state assumes the function of the pushing device 8; this is shown in FIG. 2c. The telescoping extraction of the counterpart 8′ for pushing or pulling the stroller is indicated with broken lines. The pushing device 8 can be folded in or retracted and is not shown in FIG. 2c. Analogously to the embodiment as shown in Figure 1a, in this stroller the seat element 1 and the mounting 3 form the outer sides of the stroller in collapsed state.

FIG. 3 shows one possible embodiment for protective coverings 14. The protective coverings 14 consist of a soft, preferably watertight material such as synthetic fibers and can be cushioned on the inside with foam. Two protective coverings 14 diagonally opposite one another at a time are connected to a rubber pull 15; this enables simple and stable attachment of the coverings 14. In this embodiment of the stroller a carrying handle 3 is moreover attached to a second mounting 4 and the stroller in the collapsed state can be easily transported on the handle.

In FIG. 4 the stroller in the collapsed state can be pushed or pulled like a trolley trunk. The protective covering 14 has openings for the front wheels 5 and the pushing device 8. To pack the stroller in the protective covering 14 it can be opened with a zipper or velcro closure (not shown). This protective covering 14 is made preferably of a stable fabric.

A folding pouch (not shown) can be attached to the stroller, for example, to the mounting 3 for the front wheels. The protective covering can be stored in this folding pouch, alternatively toys, diapers or other articles can also be carried there.

FIG. 5 shows how the stroller is collapsed. In the component figure a) the stroller is in the operating position. In the component figure b) the extension 10 of the seat element 1 is folded up and the seat element I is folded against the seat back 2. The pushing device 8 has been pivoted 180° against the seat back 2. In the component figure c) the seat back 2 and the seat element 1 have been folded against the mounting 4. The footrest 9 is folded into the mounting 3. In the component figure d) the two mountings 3 and 4 are folded against one another. For this purpose the transverse brace 16 must likewise be folded up.

FIG. 6 is a schematic of part of the folding device 7. On the stroller there are two such arrangements mirrored against one another on the same geometrical axis.

The stroller elements are attached to two parallel rollers 7.7. The seat surface 1 is connected to the roller 7.1, the seat back 2 to the roller 7.2, and the first mounting 3 is connected to the roller 7.3. The second mounting 4 is connected to the roller 7.4 which for its part is connected to the roller 7.6 by way of the bridge 7.5. The two central rollers 7.7 are therefore held in position against one another by way of the bridge 7.5.

The locking of the individual rollers can be done differently. In one preferred embodiment the two rollers 7.4 and 7.6 are fixed on the rollers 7.7. The other rollers are pivotally mounted on the rollers 7.7 and can be fixed with brakes. Brakes in the form of rotary brake shoes within the turning rollers are preferred. They can be locked via a spring and are tensioned via buttons in the hubs of the rollers 7.7.

Different forms of drum brakes can be used as brakes. In particular it is conceivable for the rollers 7.7 to be moreover the brake shoes of drum brakes and to be pressed against the inside wall of the roller to be fixed via a conical screw. Since force must be expended to turn the screws, it is moreover ensured that a child cannot release the brakes.

It is likewise conceivable for the locking to take place with a pin-type brake, pins being pressed through holes in the rollers 7.7 against the inside wall of the roller to be fixed. In doing so, the locking action can be improved if the inside walls of the roller are provided with indentations into which the pins fit. In any case the individual elements cannot be continuously adjusted against one another in this way. The pins can be connected via a spring mechanism to a pushbutton which is mounted in the hubs of the rollers 7.7.

Instead of brakes in the rollers, locking can also take place outside the rollers. For example it is possible to connect the mountings 3, 4 to crossbars such that the crossbars are pivotally attached to one mounting and are detachably attached to the other mounting via a toothed section. The seat element 1 and the seat back 2 can be connected in the same way, and these crossbars can then be used moreover as armrests. This form of locking does not allow continuous adjustment of the angle between the individual elements. Depending on the number of teeth in the section however different angles can be set.

One alternative preferred embodiment of the stroller as claimed in the invention is shown in FIGS. 7a-7c, 8a-8c. The folding mechanism 7 has only one axis of rotation A (FIG. 11a, 11b). The axis of rotation A is not made continuous, but is the geometrical product of two bunches of disks which can turn around this axis.

The seat 1, the seat back 2, the first mounting 3 for the front wheels 5 and the second mounting 4 for the rear wheels 6 are made of stable plastic. The weight of this stroller is clearly reduced compared to conventional metal strollers and is roughly 6 kg. The pushing device 8 likewise consists of plastic, but could also be made of a lightweight metal, for example aluminum.

The wheels 5 and 6 are conventional hard rubber wheels with aluminum rims. The rear wheels 6 are securely held in a forward alignment, while the front wheels 5 can be turned around a vertical axis. In order to facilitate travelling on uneven paths, and to simplify collapse, the front wheels 5 can be locked in the forward alignment. To do this there is one lever (not shown) for each wheel with which a pin is guided into the wheel suspension and locked there.

As shown in FIG. 7a, the mounting 3, in contrast to the example from Figure 1a, is not made from a plastic plate, but has only two lengthwise braces. Moreover a footrest 9 is attached to the mounting 3. The seat 1 is so narrow that it has room between the lengthwise braces of the mounting 3.

Projections 17 which point to the rear are attached to the seat back 2. Accessories such as a net shopping bag, sunscreen or umbrella, beverage holder or the like can be attached to these projections 17. But they are also suited for hanging coats or shopping bags, for example. As is apparent from FIG. 8c, the stroller in the collapsed position is supported on these projections.

FIG. 7b shows the stroller obliquely from the rear. A carrying handle 13 is visible under the seat I and the seat back 2. In the collapsed position the stroller is carried by this handle 13.

The brake 12 blocks the rear wheels 6. In this way the stroller is prevented from accidently rolling away.

Release levers 18 for unlocking the stroller are likewise shown in FIG. 7b. These levers 18 are arranged symmetrically with respect to the vertical stroller middle and must be actuated at the same time for the stroller to be unlocked. It is not sufficient to release only one lever 18 to unlock the stroller. This symmetrical arrangement reduces the risk that unlocking will take place inadvertently. The entire release mechanism is described in conjunction with FIG. 13.

The release lever 18 unlocks all elements of the stroller.

The side-view of the stroller in FIG. 7c shows clearly that the mounting 4 and the seat 1 are shorter than the mounting 3. The latter is roughly the same length as the seat back 2.

The collapsing process is explained in FIGS. 9a-9d. In FIG. 9a the stroller is in the operating position, the wheels 5 are locked in the forward direction. When the two trigger levers 18 (see FIG. 7b) are actuated at the same time, all elements of the stroller are moreover released.

After release, first the seat 1 falls into the free space between the lengthwise braces of the mounting 3 (FIG. 9b). There the seat is fixed by catch projections (not shown) which are attached to the mounting 3. The pushing device 8 falls forward onto the seat back 2. The seat back moves to the rear until the projections 17 rest on the ground (FIG. 9c).

The mountings 3 and 4 are prevented, as described below, from moving apart. They are pressed apart by the weight of the stroller and remain for the time being in the operating position, while the seat 1 and the seat back 2 are already collapsed.

By swivelling the seat 1 and the seat back 2 apart from one another, a carrying handle 13 becomes visible between the two elements. Only when the stroller is lifted high by this handle 13, do the mountings 3 and 4 fold against one another. The mounting 4 is so much shorter than the mounting 3 that the rear wheels 6 have room above the front wheels 5 (FIG. 8c). The stroller is then fixed in the collapsed position with catch projections (not shown) which are attached to the mounting 3.

The outer sides of the stroller in the collapsed state form the seat back 2 (FIG. 8a) and the seat 1 with the mounting 3 (FIG. 8b). The mounting 3 is slightly cranked on one disk 73 (see FIG. 15f, 15g). The entire thickness of the stroller in the collapsed state is slightly greater than the diameter of the rear wheels 6.

In FIG. 10 the folding mechanism 7 is shown enlarged. The folding mechanism comprises four plastic disks:

the disk 74 to which the mounting 4 for the rear wheels 6 is attached,

the disk 73 to which the mounting 3 for the front wheels is attached,

the disk 71 to which the seat 1 is attached, and

the disk 72 to which the seat back 2 is attached.

Furthermore a fifth disk 70 is apparent. The disk 70 is made of aluminum, but could also consist of a different material. For aesthetic reasons the disk 70 is covered with a plastic casing 70′.

FIG. 11a shows the disks without the other elements of the stroller. The casing 70′ is likewise left out.

The disk 70 is securely connected to a cylindrical, concentrically arranged cylinder shaft 75. The shaft 75 is made of a metal pipe. The other disks 71-73 are mounted to be able to pivot around the cylinder shaft 75. The axis of rotation A runs through the center point of the cylinder pipe 75. The disk 74 is securely connected to the shaft 75. For reasons of weight this disk 70 is provided with recesses 76.

FIG. 11b shows a section along the axis A from FIG. 11a. The shaft 75 is clearly visible in this view; the disks 71-74 are mounted on it. The disk 73 to which the mounting 3 for the front wheels 5 is attached has two pins 77a and 78a. These pins 77a and 78a are guided in the lengthwise grooves 77b and 78b of the disks 71 for the seat 1 and 74 for the mounting 4 of the rear wheels 6.

The lengthwise grooves 77b and 78b in FIGS. 12c and 12e which show a top view of the disks 71 and 74 are more clearly recognizable. The pins 77a and 78a are guided in these grooves 77b, 78b such that the swivel angle is relatively limited between the seat 1, the mounting 3 and the mounting 4. In particular, the grooves 77b, 78b are chosen such that the mounting 3 in the operating position is fixed by the pins 77a and 78a in the grooves 77b and 78b. This means that the pin 77a in the groove 77b is on the upper stop and the pin 78a (FIG. 11b) in the groove 78b is on the opposite, lower stop when the stroller is in the operating position.

The other disks are fixed with a wedge 80 (FIG. 14a and 14b). The disk 74 is securely connected to the pipe 75 and thus to the disk 70. The disks 70, 71 and 72 each have one catch groove 79.0, 79.1, and 79.2 as the counterpart for the fixing wedge 80.

One side of the release mechanism is shown in FIG. 13. The second side is attached mirror-symmetrically to the other side of the seat back 2 (FIG. 7b). So that unlocking occurs, the two levers 18 must be actuated at the same time.

The lever 18 is attached to a mounting 20 which is guided in a rail 19. Moreover a continuation 21 of the pushing device 8 is attached to this mounting 20. A compression spring 24 presses the mounting 20 against the outside of the seat back 2. The compression spring 24 is used to additionally safeguard the lever 18 secured in the operating position. Thus a certain expenditure of force is necessary to actuate the lever 18. The required force is so great that a child at play cannot actuate the two levers at the same time.

If the two levers 18 are moved against one another, therefore against the force of the compression spring, in the direction of the middle of the stroller, on the one hand a pin 22 is released from the groove 23. On the other hand a Bowden cable 25 is pulled.

By releasing the pin 22 from the groove 23 the pushing device 8 is released and can turn freely around the axis through the spring center. To collapse the stroller, the user gives the pushing device 8 a small push and allows it to fall onto the inside of the seat back 2.

The Bowden cable 25 is guided around the pin 26 and is attached in the projection 27 on the mounting 20. The horizontal pulling motion of the lever 18 is converted via the Bowden cable 25 into a vertical pulling motion. The force is routed to the wedge 80 (FIG. 14a and 14b). By moving the lever therefore the wedge 80 is raised. Thus all elements of the stroller are released with one release mechanism.

The wedge 80 is visible in FIGS. 14a and 14b. In FIG. 14a the seat back 2 with the disk 72 is left out. These two elements are left out in FIG. 14b.

The Bowden cable 25 is guided along the seat back 2 to the wedge 80. The wedge 80 is pressed down by a compression spring 81 into the catch grooves 79.0, 79.1 and 79.2 of the disks 70, 71, and 72. These disks are therefore fixed by the wedge in the operating position.

If the wedge 80 is raised via the Bowden cable 25, it is released from the catch grooves 79.0, 79.1 and 79.2 and the disks 71-74 can turn against one another. The collapsing process as is described in FIGS. 9a-9d is thus initiated.

In FIGS. 15a-15i the folding device of the stroller as shown in FIGS. 7a-7c is detailed in a perspective view. FIG. 15a shows one half of the entire joint. The plastic casing 70′ is left out. The disks 70 to 74 can be clearly recognized next to one another. The wedge 80 keeps the disks 70 to 74 in the operating position. On the other side of the stroller is the same arrangement, mirror-symmetrically. The disks can only be unlocked when the wedge 80 is released both on the two sides of the stroller.

Only the disk 72 is inserted in FIG. 15b and 15c. FIG. 15b represents a view of the disk 72 from the outside of the stroller. FIG. 15c shows the disk 72 from the inside, therefore from the middle of the stroller. The disk 72 is pivotally mounted on the cylinder shaft 75. The seat back 2 is securely connected to the disk 72. When the wedge 80 is pulled out of the groove 79.2, the disk 72 and thus the seat back 2 are folded around the shaft 75.

FIG. 15d shows the disks 70 and 71 in a view from the stroller middle. The disk 70 is permanently welded to the cylinder shaft 75. The disk 71 can turn around the shaft 75. The two disks 70 and 71 are fixed by the wedge 80 in the grooves 79.0 and 79.1. The compression spring 81 presses the wedge 80 into the groove 79.0 and 79.1. The seat 1 which is securely connected to the disk 71 is thus held in the operating position.

FIG. 15e shows the disks 71 and 72 from the outside of the stroller. The wedge 80 keeps the two disks 71 and 72 in the operating position. The lengthwise grooves 77b which are formed in the disk 71 are clearly visible. To improve stability there are two lengthwise grooves 77b in which one pin 77a (FIG. 15f) runs.

FIGS. 15f and 15g show the disks 70 and 73 in interplay. FIG. 15f shows the two disks 70 and 73 in a view from the stroller middle. The disk 73 is connected to the mounting 3 for the front wheels 5.

The disk 73 does not have a catch groove for the wedge and is accordingly not directly fixed by the wedge 80. The pins 77a and 78a on the two sides of the disk 73 are used to limit the swivel angle of the disk 73 on the one hand and to fix the disk 73 on the other. In the operating position the pins 77a are on a stop of the lengthwise grooves 77b and the pins 78a is on the opposite stop of the lengthwise grooves 76b. The disk 73 is thus fixed in the operating position by the bordering disks 71 and 74 which in turn are held in their position by the wedge 80.

Figure 15g shows the disks 70 and 73 from the outside of the stroller. The two pins 78a which run in the lengthwise grooves 78b (FIG. 15h) are clearly visible. Likewise it can be easily recognized that the mounting 3 for the front wheels does not protrude radially from the axis of rotation A (FIG. 11a, 11b) which is determined by the middle axis of the cylinder 75, but is pushed slightly in the tangential direction. In this way the mounting 3 can be folded with high precision parallel to the remaining elements of the stroller. Moreover the mounting 3 slightly cranked is attached to the disk 73. This shows that the mounting 3 is guided in a slight arc to the disk 73.

FIGS. 15h and 15i show the two disks 70 and 74. FIG. 15h shows the two disks 70 and 74 in a view from the stroller middle, in FIG. 15i they are shown from the outside of the stroller. The disk 74 is securely joined to the shaft 75, in this example riveted to it. Thus the disk 74 is also indirectly fixed by the wedge 80 which catches in the groove 79.0 of the disk 70.

The lengthwise grooves 78b are clearly visible in FIG. 15h. The pins 78a are guided in these lengthwise grooves. In this way the swivel angle between the two mountings 3 and 4 is limited. The lengthwise grooves 78b and the pins 78a are arranged to one another such that the pins 76a in the operating position strike the end of the corresponding lengthwise groove 78b. In this way the two mountings 3 and 4 cannot fold farther apart from one another than is provided in the operating position. When the wedge 80 is released, the mountings 3 and 4 can be swivelled against one another only in one direction. This prevents the stroller from folding farther apart than desired as it is being collapsed.

FIG. 15i furthermore shows that the mounting 4 (analogously to the mounting 3, FIG. 15g) does not run radially to the axis of rotation A (FIG. 11a, 11b) which is defined by the center axis of the cylinder 75. Compared to FIG. 15g, it is conspicuous that the mounting 4 with respect to the mounting 3 is offset to the opposing side of the axis A. If the two mountings 3 and 4 are folded against one another, they are aligned almost perfectly parallel against one another. The stroller can thus be collapsed in a very space-saving manner.

1. A collapsible stroller comprising a seat element, a seat back, a first mounting for at least one front wheel, a second mounting for at least two rear wheels, and a pushing device and a folding device,
wherein the seat element, the seat back and the first and the second mounting are attached to the folding device on one side to be able to pivot around it,
the folding device has pivot joints for pivoting of the seat element, the seat back and the first and the second mounting, and
the folding device has a first position which corresponds to the operating position of the stroller, and a second position in which the stroller is collapsed.

2. A stroller as claimed in claim 1, wherein the folding device can be fixed in the first position, and, for collapsing the stroller out of the first into the second position, further comprising a release mechanism for simultaneously releasing at least two elements from the group of the seat, the seat back ,the first and the second mounting and the pushing device.

3. A stroller as claimed in claim 1, further comprising a release mechanism for simultaneously releasing the seat, the seat back, the first and the second mounting and the pushing device.

4. A stroller as claimed in claim 1, wherein the release mechanism comprises a Bowden cable.

5. A stroller as claimed in claim 1, wherein, in the collapsed position, the seat element, the seat back and the first and the second mounting are arranged roughly parallel to one another, protruding from the folding device.

6. A stroller as claimed in claim 1, wherein the seat element, the seat back and the first and the second mounting in the operating position are arranged roughly in a star shape around the folding device.

7. A stroller as claimed in claim 1, wherein in the operating position the angles between the seat element, the seat back and the first and the second mounting can be continuously fixed or can be selected from a given number of positions.

8. A stroller as claimed in claim 1, wherein the pivot joints of the seat element, the seat back and the first and the second mounting are located flush on an axis of rotation.

9. A stroller as claimed in claim 1, wherein the pivot joints of the seat element, the seat back and the first and the second mounting are located flush on two or three parallel axes of rotation.

10. A stroller as claimed in claim 1, further comprising a stop for limiting the pivoting motion for at least one of the elements of the group of the seat, the seat back and the first and the second mounting.

11. A stroller as claimed in claim 10, further comprising means for fixing the stroller in the collapsed position.

12. A stroller as claimed in claim 1, wherein the seat back has projections for supporting the stroller in the collapsed position.

13. A stroller as claimed in claim 1, further comprising at least one carrying handle for carrying the stroller in the collapsed position.

14. A stroller as claimed in claim 13, wherein the carrying handle is attached laterally to the seat element, to the seat back or to one of the mountings.

15. A stroller as claimed in claim 1, further comprising a footrest attached to the first mounting.

16. A stroller as claimed in claim 1, wherein the pushing device is attached to the seat back.

17. A stroller as claimed in claim 1, wherein the pushing device is pivotally attached to the folding device.

18. A stroller as claimed in claim 1, wherein the pushing device can be adjusted in length.

19. A stroller as claimed in claim 1, wherein, in the collapsed position, the lower surface of the seat element and the first mounting are the outer sides of the stroller.

20. A stroller as claimed in claim 19, wherein the seat element has a folding or telescoping extension.

21. A stroller as claimed in claim 1, wherein the front wheels and/or the rear wheels can be pivoted roughly 90° against the stroller.

22. A stroller as claimed in claim 1, wherein the front wheels and/or the rear wheels in the collapsed position project beyond the other elements and can be used to push or pull the stroller.

23. A stroller as claimed in claim 1, further comprising protective coverings for the stroller in the collapsed position.
